(19) United States
(12) Patent Application Publication
(10) Pub. No.: US 2015/0380868 A1
(43) Pub. Date: Dec. 31, 2015

(54) CONNECTOR ASSEMBLY

(71) Applicant: SPEED TECH CORP., TAOYUAN HSIEN (TW)

(72) Inventors: Chih-Cheng CHEN, Taoyuan Hsien (TW); Cheng-Hsiang HSUEH, TAOYUAN HSIEN (TW)

(21) Appl. No.: 14/462,583

(22) Filed: Aug. 19, 2014

(30) Foreign Application Priority Data
Jun. 27, 2014 (TW) 103211547

(51) Int. Cl. H01R 13/6581

(52) U.S. Cl. CPC H01R 13/6581

(57) ABSTRACT

The present invention relates to a connector assembly, which includes a first plastic body, a second plastic body, a grounding sheet, a plurality of first terminals, a plurality of second terminals and a shielding case. The first terminals are insert-molded in the first plastic body. The second terminals are insert-molded in the second plastic body. The grounding sheet is disposed between the first plastic body and the second plastic body. The first plastic body has a first fixing part. The second plastic body has a second fixing part.

The first fixing part and the second fixing part are engaged with each other, thus the first fixing part and the second fixing part are assembled and fixed to each other. The shielding case covers the first plastic body and the second plastic body to form an abutting space.

### RELATED APPLICATIONS

This application claims priority to Taiwan Application Serial Number 103211547, filed Jun. 27, 2014, which is herein incorporated by reference.

### BACKGROUND

1. Field of Invention

The present invention relates to a connector assembly. More particularly, the present invention relates to an assembly structure with no plastic deformation when a heating type of a surface mounting technology is performed on two rows of terminals at the same time.

2. Description of Related Art

Electrical connectors, such as USB connectors and HDMI connectors, are widely used in a communication field. How to decrease the fabricating cost of the electrical connector is an important factor for obtaining a competitive position in markets. A key element of the electrical connector is a terminal module, which usually includes an insulating body and terminals partly supported in the insulating body. The terminal module of an existing electrical connector often includes two sets of the terminals, and the two sets of the terminals are insert-molded in plastic. In order to control a position accuracy of the two sets of the terminals effectively, the two sets of the terminals are respectively manufactured in a fabrication process of the terminal modules, which means that the two sets of the terminals are insert-molded in two plastics respectively. Then, the two insert-molded terminal modules are assembled and combined with each other. Finally, the two combined insert-molded terminal modules are fixed to a metal shell simultaneously for forming the electrical connector.

As described above, the fabrication method provides an electrically connecting method, in which two rows of terminals can be positioned to a circuit board through a surface mounting technology (SMT) simultaneously. As shown in FIG. 7, the Taiwan patent number M443957 provides an electrical connector, which has a tongue-shaped plate A11 in front of a base body A1. A cap plate A2 is combined to and positioned on the base body A1. A terminal set A3 is positioned between the base body A1 and the cap plate A2. A first shell A4 covers and is positioned outside the base body A1 and the cap plate A2. Sidewall surfaces A42 at two sides of the first case A4 have buckle parts A43. A base part A51 of a second case A5 may be abutted on the first case A4, such that side plates A52 at two sides of the base part A51 can be positioned by buckling hook parts A53 to the corresponding buckle parts A43 on the first case A4. Positioning parts A54 below the two side plates A52 are welded on a circuit board (not shown) for forming a jointed grounding loop. The first case A4 is tied up by the second case A5, thereby preventing the first case A4 and the second case A5 from being lifted upward or damaged structurally when an outer plug (not shown) is plugged in or out.

Because the terminal set A3 on the cap plate A2 is exposed by the cap plate A2, the terminal set A3 cannot be protected by the cap plate A2 directly. It means that the terminal set A3 is not easy to keep a stable status during fabrication, and the terminal set A3 is easily bent, broken or damaged by an unexpectedly external factor during the process. Further, when a surface mounting technology is performed on the terminal set A3, the base body A1 and the cap plate A2 easily suffer from heating deformation, and an entire yield cannot be improved, thereby causing an issue to be resolved in production.

### SUMMARY

The present invention is directed to a connector assembly, in which two sets of terminals are respectively insert-molded in two plastic pieces, and the two plastic pieces are assembled and buckled up with each other. An entire stable force of the two sets of terminals is improved by a structural cooperation of buckling elements. Thus, when a surface mounting technology is simultaneously performed on the two sets of the terminals, a condition, which the two encasing plastic pieces are separated from each other and cannot flatly contact with each other due to heating deformation is decreased. Further, the connector assembly has a relatively simple structure in product design, and a production yield is effectively enhanced in end product process.

The invention discloses a connector assembly, which includes a first plastic body, a second plastic body, a grounding sheet, a plurality of first terminals, a plurality of second terminals and a shielding case. The first terminals are insert-molded in the first plastic body. Each of the first terminals has a first contact part, a first home part and a first welding part. The first home part is embedded in the first plastic body. The first contact part is used for electrically connecting to an abutting plug. The first welding part is used for electrically connecting to a circuit board. The second terminals are insert-molded in the second plastic body. Each of the second terminals has a second contact part, a second home part and a second welding part. The second home part is embedded in the second plastic body. The second contact part is used for electrically connecting to an abutting plug. The second welding part is used for electrically connecting to a circuit board. The grounding sheet is disposed between the first plastic body and the second plastic body. A plurality of grounding terminals are disposed on the grounding sheet. Each of the grounding terminals is electrically connected to each of the corresponding first terminals and each of the corresponding second terminals for forming a grounding effect. The shielding case covers the first plastic body and the second plastic body for forming an abutting space, in which the first plastic body has a first fixing part, and the second plastic body has a second fixing part. The first fixing part and the second fixing part are engaged with each other, thus the first plastic body and the second plastic body are assembled and fixed to each other.

In the present invention, the first plastic body has a first base part which extends forwards to form a first tongue-shaped plate. A thickness of the first tongue-shaped plate is smaller than that of the first base part. The first fixing part is protruding extendedly from two ends of the first tongue-shaped plate. The second plastic body has a second base part which extends forwards to form a second tongue-shaped plate. A thickness of the second tongue-shaped plate is smaller than that of the second base part. The second fixing part is concaved in two ends of the second tongue-shaped plate. The first fixing part is buckled in the second fixing part such that the first fixing part and the second fixing part contact with each other flatly and closely.

In the present invention, the first plastic body has a buckling block, and the second plastic body has a buckling groove corresponding to the buckling block. The buckling block is buckled in the buckling groove, such that the first base part is buckled and positioned in the second base part, and the first plastic body is assembled and positioned in the second plastic body correspondingly. In addition, the second plastic body has a concave part, and the grounding sheet is disposed in the concave part to form a second surface. The first plastic body has a first surface opposing to the second surface, and the first surface and the second surface is flatly adhered to each other. Further, the first welding parts of the first terminals and the second welding parts of the second terminals are connected to a circuit board using a method conforming to a type of a surface mount technology.

Other applications of the present invention are apparent according to the specification of the invention. However, the disclosure of the specification of the invention is realized in a way that a first fixing part and a second fixing part are buckled to each other such that the encasing plastic pieces is not easily deformed and separated from each other when the surface mount technology is performed on the terminals. Further, the connector assembly has a simple structure, and a production process can be simplified and the production cost can be decreased effectively. The design manners used by those skilled in the art utilizing other similar principles still fall within the scope of the invention.

### BRIEF DESCRIPTION OF THE DRAWINGS

FIG. 1 is a three-dimensional appearance diagram showing a preferred embodiment of this invention from a first visual angle.

FIG. 2 is a three-dimensional appearance diagram showing a preferred embodiment of this invention from a second visual angle.

FIG. 3 is a three-dimensional appearance diagram showing an inner structure of a preferred embodiment of this invention from a first visual angle.

FIG. 4 is a three-dimensional appearance diagram showing an inner structure of a preferred embodiment of this invention from a second visual angle.

FIG. 5 is a three-dimensional explosion diagram showing a preferred embodiment of this invention from a first visual angle.

FIG. 6 is a three-dimensional explosion diagram showing a preferred embodiment of this invention from a second visual angle.

FIG. 7 is a three-dimensional explosion diagram showing a Taiwan patent number M443957.

### DETAILED DESCRIPTION

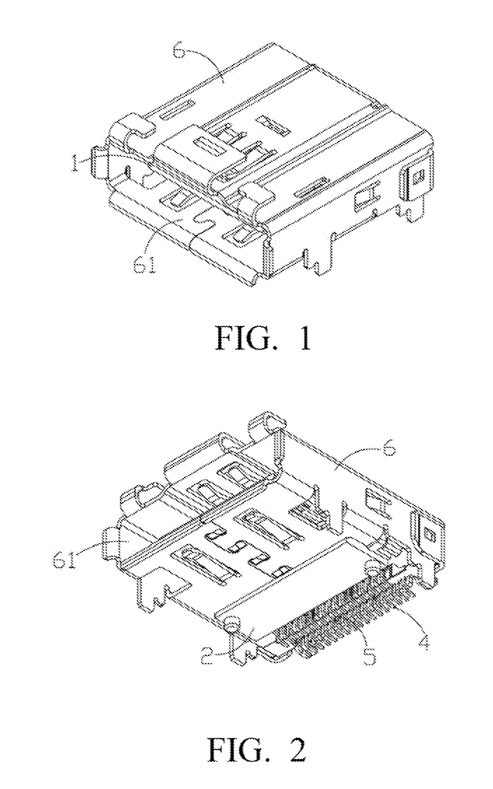

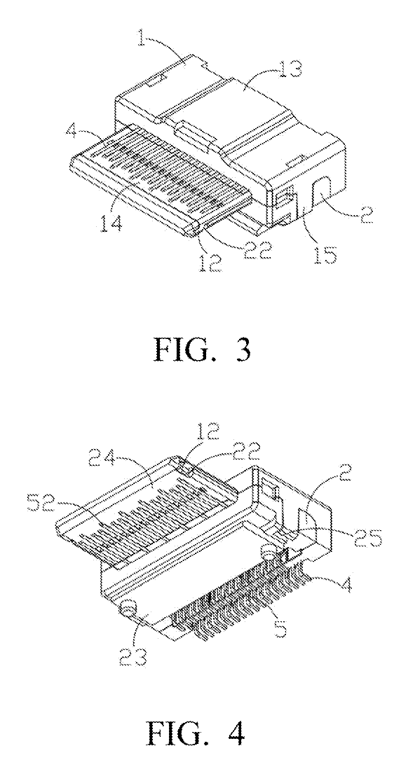

As shown in FIG. 1 to FIG. 5, the invention provides a connector assembly, which includes a first plastic body 1, a second plastic body 2, a grounding sheet 3, a plurality of first terminals 4, a plurality of second terminals 5 and a shielding case 6. The first terminals 4 are positioned in the first plastic body 1 by using an insert-molded method. Each of the first terminals 4 has a first home part 41, and a first contact part 42 and a first welding part 43 are respectively formed to extend outwardly from two ends of the first home part 41. The first home part 41 is entirely embedded in the first plastic body 1. The first plastic body 1 further has a plurality of first slots 11. The first contact parts 42 are disposed in the first slots 11. The first contact parts 42 are used for electrically connecting to an abutting plug (not shown). The first welding parts 43 are exposed by the first plastic body 1, and the first welding parts 43 are used for electrically connecting to a circuit board (not shown).

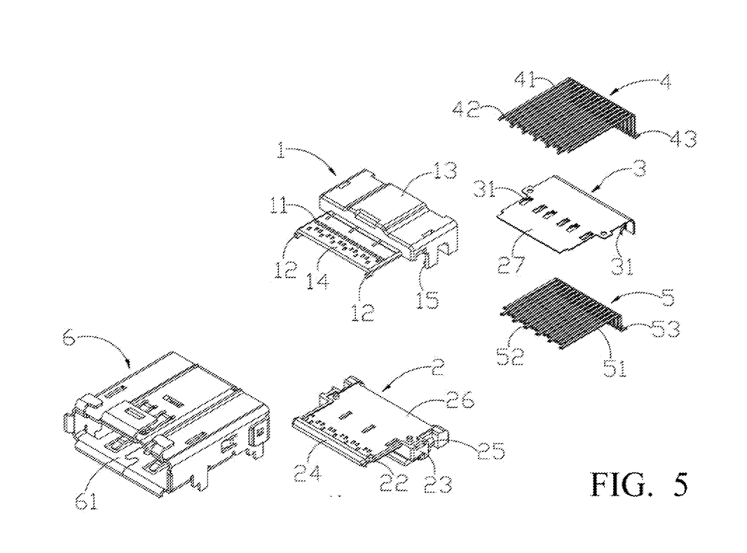

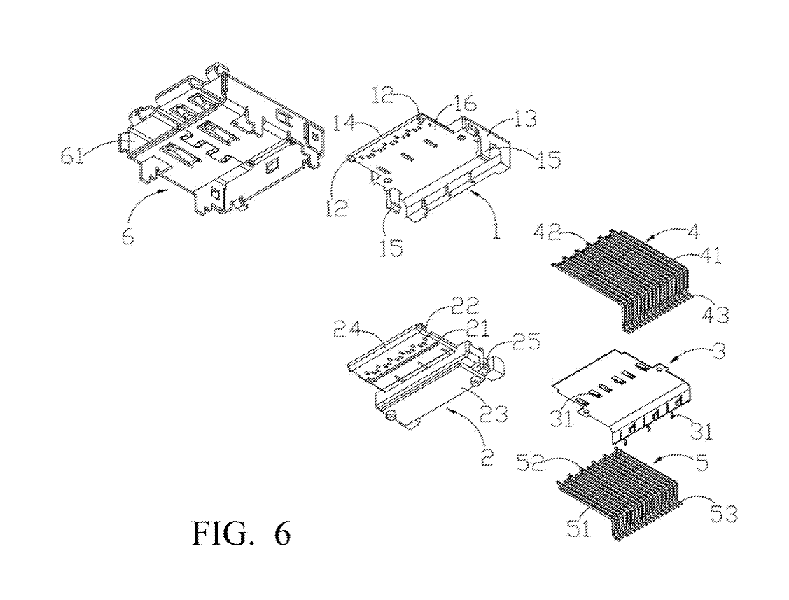

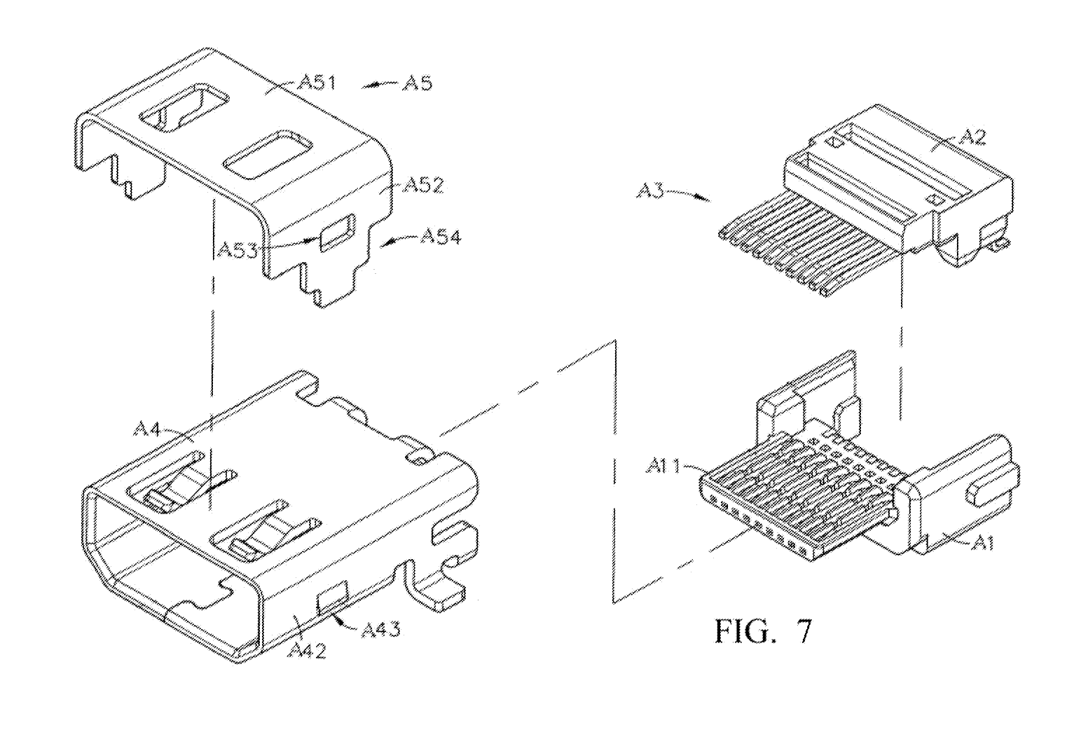

As shown in FIG. 5 and FIG. 6, in a preferred embodiment of this invention, the second terminal 5 are insert-molded in the second plastic body 2. Each of the second terminals 5 has a second home part 51, and a second contact part 52 and a second welding part 53 are respectively formed to extend outwardly from two ends of the second home part 51. The second home part 51 is entirely embedded in the second plastic body 2. The second plastic body 2 further has a plurality of second slots 21. The second contact parts 52 are disposed in the second slots 21. The second contact parts 52 are used for electrically connecting to an abutting plug (not shown). The second welding parts 53 are exposed by the second plastic body 2, and the second welding parts 53 are used for electrically connecting to a circuit board (not shown). The grounding sheet 3 is disposed between the first plastic body 1 and the second plastic body 2. A plurality of grounding terminals 31 are disposed on the grounding sheet 3. Each of the grounding terminals 31 is electrically connected to each of the corresponding first terminals 4 and each of the corresponding second terminals 5 for forming a grounding effect, thereby decreasing an electromagnetic interference and improving transmitting signal stability of each of the other first terminal's 4 and each of the other second terminals 5. The shielding case 6 covers the first plastic body 1 and the second plastic body 2 for forming an abutting space 61, and the abutting space 61 is used for accommodating a plug connector (not shown). Further, the first plastic body 1 has a first fixing part 12. The first fixing part 12 is shown as an outward L-shaped bump. The second plastic body 2 has a second fixing part 22. The second fixing part 22 has a receiving space which is concaved inwardly and can receive the first fixing part 12 correspondingly. The first fixing part 12 and the second fixing part 22 are engaged with each other, and thus the first plastic body 1 and the second plastic body 2 are assembled and fixed to each other.

As shown in FIG. 4 to FIG. 6, in a preferred embodiment of this invention, the first plastic body 1 has a first base part 13. A first tongue-shaped plate 14 is formed to extend forwards from the first base part 13 near a bottom edge of the first base part 13. The first slots 11 are disposed in the first tongue-shaped plate 14. A thickness of the first tongue-shaped plate 14 is smaller than that of the first base part 13. The first fixing parts 12 protrude and extend from two ends of the first tongue-shaped plate 14. Further, the second plastic body 2 has a second base part 23. A second tongue-shaped plate 24 is formed to extend forwards from the second base part 23 near a top edge of the second base part 23. The second slots 21 are disposed in the second tongue-shaped plate 24. A thickness of the second tongue-shaped plate 24 is smaller than that of the second base part 23. The second fixing parts 22 are concaved in two ends of the second tongue-shaped plate 24. The first fixing parts 12 are fixed to the second fixing parts 22 such that the first tongue-shaped plate 14 and the second tongue-shaped plate 24 contact with each other flatly and closely.

As shown in FIG. 5 and FIG. 6, in a preferred embodiment of this invention, the first plastic body 1 has buckling blocks 15 formed in a barb shape. The second plastic body 2 has buckling grooves 25 corresponding to the buckling blocks 15. The buckling blocks 15 are buckled in the buckling grooves 25, such that the first base part 13 is buckled and positioned to the second base part 23 to assemble and position the first plastic body 1 in the second plastic body 2 correspondingly. The second plastic body 2 has a concave part 26, and an area of the concave part 26 is substantially the same as that of the grounding sheet 3, such that the grounding sheet 3 can be easily disposed in the concave part 26 to form a second surface 27. The first plastic body 1 has a first surface 16 opposing to the second surface 27, and the first surface 16 and the second surface 27 flatly contact with each other. Further, the first welding parts 43 of the first terminals 4 and the second welding parts 53 of the second terminals 5 are connected to a circuit board using a method conforming to a type of a surface mount technology.

Although the present invention has been described above as in detailed description, it is not used to limit the present invention. It will be intended to those skilled in the art that various modifications and variations can be made to the present invention without departing from the scope or spirit of the invention. Therefore, the scope of the invention is to be defined solely by the appended claims.

What is claimed is:

1. A connector assembly, comprising:
a first plastic body having a first fixing part;
a second plastic body having a second fixing part, wherein the first fixing part and the second fixing part are engaged with each other, thus the first fixing part and the second fixing part are assembled and fixed to each other;
a plurality of first terminals insert-molded in the first plastic body;
a plurality of second terminals insert-molded in the second plastic body;
a grounding sheet disposed between the first plastic body and the second plastic body; and
a shielding case covering the first plastic body and the second plastic body.

2. The connector assembly of claim 1, wherein the first plastic body has a first base part which extends forwards to form a first tongue-shaped plate, and the first fixing part is protruding extendedly from two ends of the first tongue-shaped plate.

3. The connector assembly of claim 1, wherein the second plastic body has a second base part which extends forwards to form a second tongue-shaped plate, and the second fixing part is concaved in two ends of the second tongue-shaped plate.

4. The connector assembly of claim 1, wherein the first plastic body has a buckling block and the second plastic body has a buckling groove relative to the buckling block, and the buckling block is buckled in the buckling groove.

5. The connector assembly of claim 1, wherein the second plastic body has a concave part, and the grounding sheet is disposed in the concave part.

6. The connector assembly of claim 1, wherein the first terminals and the second terminals conform to a type of surface mount technology.
